(19) United States
(12) Patent Application Publication
(10) Pub. No.: US 2011/0320242 A1
(43) Pub. Date: Dec. 29, 2011

(54) MULTI-VARIATE SALES PERFORMANCE ANALYSIS SYSTEM

(76) Inventor: Marc A. Cohen, McLean, VA (US)

(21) Appl. No.: 13/165,589

(22) Filed: Jun. 21, 2011

Related U.S. Application Data
(60) Provisional application No. 61/357,673, filed on Jun. 23, 2010.
(60) Provisional application No. 61/439,646, filed on Feb. 4, 2011.

(51) Int. Cl. G06Q 10/00

(52) U.S. Cl. 705/7.42

(57) ABSTRACT

A data collecting and processing system captures the actions of sales personnel and presents performance metrics in accordance with specific corporate-wide assessment criteria. By using a system that standardizes the data collected, the performance metrics, and the assessment criteria, corporations can establish performance standards and goals beyond the traditional revenue v. cost of sales criteria. Because the performance standards and goals may be defined and presented based on the standardized assessment criteria, each salesperson's behavior can be attuned to achieve the established goals. As the system continues to be used, the assessment criteria may be fine tuned as particular metrics prove to be particularly relevant to generating revenue or developing future sales. Trend analysis and other tools may also be used to develop correlations between the actions of sales personnel and the likelihood of future success.

This application claims the benefit of U.S. Provisional Patent Applications 61/357,673, filed 23 Jun. 2010 and 61/439,646, filed 4 Feb. 2011.

### BACKGROUND AND SUMMARY OF THE INVENTION

This invention relates to the field of performance analysis systems, and in particular to a sales performance analysis system that analyzes sales performance based on multiple activities and performance factors.

Particularly in high-tech fields, the role of a salesperson is multifaceted. Merely assessing performance based on the “bottom line” is insufficient, and generally very short-sighted. Corporations that set standards and rewards based on current revenues run the risk of losing future sales to corporations that focus on long term growth.

As new products in new technologies are developed, it is often unclear exactly who might be interested. In consumer electronics, a sufficiently large market may exist such that market surveys can be used to reliably predict the target customer base for a new product, but in low-quantity, high-price specialty markets, predicting the target customer base is often a hit-or-miss process, and the corporations that are quickest to discover new clients are more likely to gain market share.

In high-price specialty markets, sales will generally consist of a small number of large valued sales, with relatively long gaps between actual sales. During these gaps in sales, the salesperson's task is to seek opportunities to sell additional products or features to existing clients, as well as to identify new potential clients. If the product is a new technology, identifying new potential clients can be a challenge, because not only does the salesperson need to determine which person in which company might be interested in the product, the salesperson needs to be able to convince that person that the company needs a product that they hadn't even heard of before the salesperson made contact.

A salesperson that spends a lot of time cultivating relationships with existing clients is likely to generate more revenue than one who waits for the client to call; however, a salesperson that spends a lot of time searching for new opportunities is likely to better assure long-term revenues than one who relies on existing clients. To assure a corporation's current and future revenue stream in specialty markets, each salesperson must properly manage the balance between identifying opportunities among existing clients and identifying new potential clients, and sales managers must be able to appropriately assess the performance of each salesperson in view of these conflicting demands.

Current sales performance systems easily distinguish each salesperson's performance based on revenue and the costs associated with obtaining that revenue, but are woefully inadequate for dealing with non-revenue performance measures. Sales managers in specialty markets must generally provide a subjective assessment of each salesperson's non-revenue measures, and each sales manager may have his/her particular technique and basis for making such an assessment. From a corporate viewpoint, such varied assessments make the task of establishing standards for distinguishing good sales performance from poor sales performance, which may explain why most corporations rely on sales performance analysis systems that assess performance based on revenue and cost of sales alone.

Viewed from another perspective, performance analysis based on revenue and cost of sales involves ‘looking back’ on achievements, and does not address ‘predicting’ future achievements. If a salesperson's reward for performance, in terms of raises, promotions, etc., is based on past achievements, as is typically the case, the only real incentive for a salesperson to find new opportunities is the salesperson's personal views regarding the tradeoffs between maximizing current income and assuring future income. Some of these personal views may be coincident with the corporate view, and some may not. Even if a particular salesperson's views are generally consistent with the corporate view, events in the salesperson's life may introduce temporary deviations that are inconsistent with the corporate view. In a performance analysis system that is based on past and current achievements, such deviations may go unnoticed until the consequences of such deviations become apparent, which may be too late for recovery actions.

It would be advantageous to provide a sales performance analysis system that assesses performance based on factors other than revenue and costs of sales, and in particular, it would be advantageous to provide a sales performance analysis system that provides an assessment of performance based on metrics associated with securing new clients. It would also be advantageous to provide a sales performance analysis system whose output is substantially independent of subjective biases. It would also be advantageous to provide a sales performance analysis system that provides an assessment of performance based on predictions of success in achieving corporate goals.

These advantages, and others, can be realized by a data collecting and processing system that captures the actions of sales personnel and presents performance metrics in accordance with specific assessment criteria. By using a system that standardizes the data collected, the performance metrics, and the assessment criteria, corporations can establish performance standards and goals beyond the traditional revenue v. cost of sales criteria. Because the performance standards and goals may be defined and presented based on the standardized assessment criteria, each salesperson's behavior can be attuned to achieve the established goals. As the system continues to be used, the assessment criteria may be fine tuned as particular metrics prove to be particularly relevant to generating revenue or developing future sales. Trend analysis and other tools may also be used to develop correlations between the actions of sales personnel and the likelihood of future success.

### BRIEF DESCRIPTION OF THE DRAWINGS

The invention is explained in further detail, and by way of example, with reference to the accompanying drawings wherein:

FIG. 1 illustrates an example flow diagram for a processing system that facilitates standardized sales performance analysis.

FIG. 2 illustrates an example individual sales performance summary.

FIG. 3 illustrates an example peer sales performance summary.

FIG. 4 illustrates an example display of individual actions as a function of time of day and day of the month.

Throughout the drawings, the same reference numerals indicate similar or corresponding features or functions. The drawings are included for illustrative purposes and are not intended to limit the scope of the invention.

### DETAILED DESCRIPTION

In the following description, for purposes of explanation rather than limitation, specific details are set forth such as the particular architecture, interfaces, techniques, etc., in order to provide a thorough understanding of the concepts of the invention. However, it will be apparent to those skilled in the art that the present invention may be practiced in other embodiments, which depart from these specific details. In like manner, the text of this description is directed to the example embodiments as illustrated in the Figures, and is not intended to limit the claimed invention beyond the limits expressly included in the claims. For purposes of simplicity and clarity, detailed descriptions of well-known devices, circuits, and methods are omitted so as not to obscure the description of the present invention with unnecessary detail.

This invention is presented in the context of a corporate sales force that is organized by sales groups, such as regional sales offices; however, one of skill in the art will recognize that this invention is not limited to any particular organizational structure.

As noted above, this invention facilitates the standardization of sales performance analysis among and within groups of salespersons in performance aspects that extend beyond the conventional standards based on revenue v. the cost of sales. Accordingly, in addition to conventional sales records being maintained for each salesperson, records of the actions of the salesperson are recorded, even those actions that do not immediately, or ever, result in a sale. These records may be stored on any of a variety of computer readable storage devices, herein defined collectively as a database.

The specific ‘extended’ records that are kept will be dependent upon the corporate-defined performance goals and standards, and the types of actions that are correlated to these goals and standards (for ease of reference, the term ‘goal’ will be used hereinafter to refer to the goals, standards, requirements, objectives, etc. of the corporation). The fact that any particular action is correlated to a defined goal may be based on any of a variety of factors, which could range, for example, from statistical studies to a consensus among senior sales and management personnel. In a preferred embodiment of this system, the type of actions being recorded may be modified as the collection and analysis of these actions provide a more quantitative assessment of the correlations between such actions and goals.

In a typical embodiment of this invention, the recorded actions will include all contacts made or attempted by each salesperson. Other actions may include, for example, the actions associated with attempting to identify potential customers, such as investigations of a company's web-site to determine whether that company is involved in tasks that are addressed by the corporation's products, and further investigations to determine the person or group responsible for that particular task.

Action records will generally include an identifier of the salesperson, a time frame associated with the action, and an identifier of the object of the action, such as an identifier of the client, or potential client. In a preferred embodiment of this invention, some or all of these action records may be created based on entries in the salesperson's computer-readable calendar. The action records may also include supplemental information, such as whether this action is the salesperson's first action with the identified action object, whether the action was actually accomplished, the results of the action, follow-up actions, and so on. By providing a common base for recording the actions of each salesperson, the method of processing the records to facilitate both individual and comparative performance analysis can be performed in a standard manner, consistent with the corporation's goals.

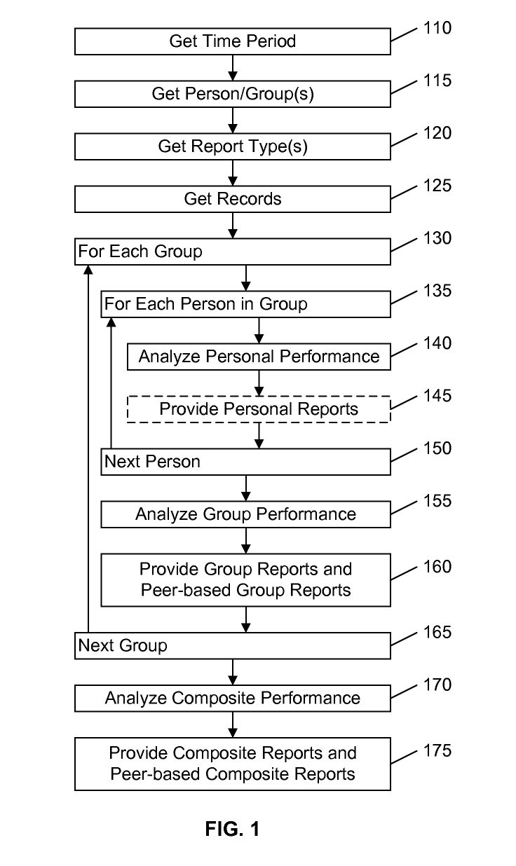

FIG. 1 illustrates a flow diagram for a processing system that facilitates standardized sales performance analysis. At 110, the user identifies the time period of interest, typically by selecting from among preset options or by inputting a specific date range. The user may also indicate how far ahead to consider forecasted sales.

At 115, the user identifies the salesperson(s) or group(s) of interest. As noted above, this invention is particularly well suited for assessing each salesperson's performance relative to the other salespeople in the salesperson's group, or other groups. For ease of reference, such comparative assessments are termed ‘peer-based’ assessments.

At 120, the user identifies the type of report(s) that is/are to be produced, and, based on the selected time and group(s), the system obtains the records necessary to produce the report(s), at 125. As noted above, in addition to the conventional sales records, the system will also provide analyses and reports based on the aforementioned action records.

Each of the groups of interest are processed via the loop 130-165, and the records of each of the salespeople in the group, or each selected salesperson in the group, are analyzed via the loop 135-150. The individual performance of each salesperson is analyzed at 140 based on the corresponding sales and actions records, and an optional individual report is provided, at 145.

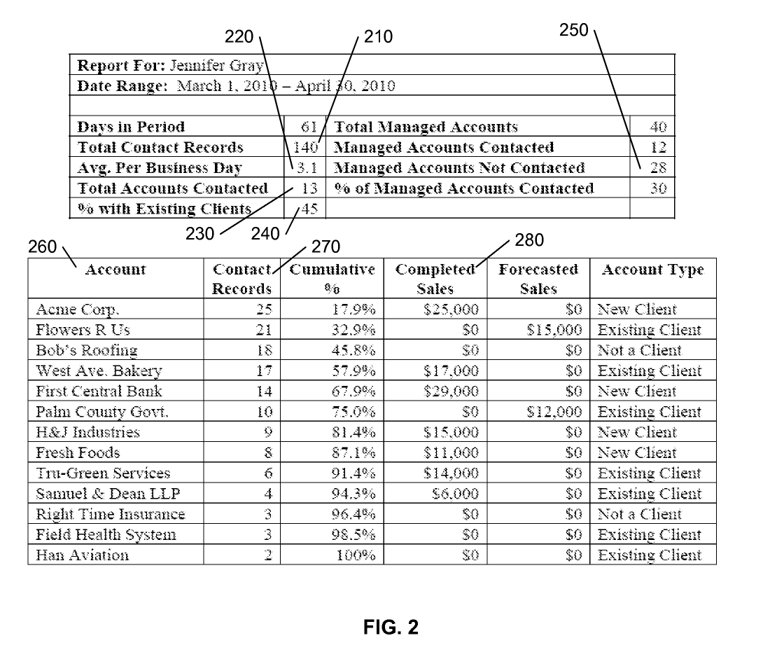

An example individual performance report is illustrated in FIG. 2. The individual report provides an overview of the information contained in the sales and action records for the salesperson during the selected time frame. In this example, the actions of interest include ‘contacts’ with existing and potential clients/accounts, and the individual report provides summary information, such as the total number of contacts 210, average contacts per day 220, total number of accounts contacted 230, the percentage of this total associated with existing clients 240, and so on.

In a preferred embodiment, hyperlinks are provided between the displayed performance data and the raw data. For example, a hyperlink might be provided from the “Managed Accounts Not Contacted” cell 250 to an actual listing of the managed accounts that were not contacted during the designated time period.

In the Example of FIG. 2, the performance of the salesperson with regard to each of the identified clients/accounts 260 is presented. As contrast with conventional client reports, the example report indicates non-revenue information, including, for example, the number of contacts 270 with the client, or potential client, during the evaluation time period. Of particular note, the format of this example report implicitly conveys the importance that this particular corporation places in making contact with clients, because the rows are sorted by the number of contacts 270, rather than the traditional sort by completed sales 280. Similarly, the report is not restricted to existing clients/accounts. Again, by providing for the collection of a common set of sales and actions records among all salespersons, the corporation can create performance reports that reinforce its views regarding the aspects of a salesperson's performance that are consistent with the goals of the corporation.

As noted above, the corporation may set goals for the sales personnel, and this individual report provides an overview of the metrics that are used to assess the performance of the individual with respect to these goals. For example, if the organization's goal is to expand its customer base, the average contacts per day should be high, while the percentage of contacts with existing clients should be low. As noted above, however, the interpretation of ‘high’ and ‘low’ in this context are somewhat subjective. In accordance with aspects of this invention, detailed further below, the performance evaluation system is configured to use the individual assessment metrics for all of the members of the group or the corporation to provide an objective and quantifiable comparison of each salesperson with each of the other salespersons, to distinguish those salespersons whose actions are expected to better achieve the corporate goals than others, and to identify those salespersons whose actions are inconsistent with achieving the corporate goals.

It should be noted that although the default order of presentation will be set by the corporation, preferred embodiments of this invention allow the user to select the sort-order based on one or more of the displayed columns. In this manner, for example, a sales manager may present alternative views to the salesperson while providing feedback as to the pros and cons of that salesperson's actions in view of the corporate goals. One of skill in the art will recognize that other presentations of the information gleaned from the sales and action records may also or alternatively be provided.

After assessing the performance of each of the salespersons in a group, the system assesses the overall group performance, at 155, and provides, at 160, the group reports and peer-based group reports that were selected at 120. In like manner, after assessing the performance of all of the salespersons in all of the groups, the system analyzes the composite corporate performance, at 170, and provides corporate reports and peer-based corporate reports at 175.

The group and corporate reports will generally be similar to the aforementioned individual reports. Metrics are determined and presented based on the records associated with the group or corporation, including, for example, total number of contacts made by the group/corporation, percentage of contacts with existing clients, and so on.

The peer-based reports are designed to contrast the performance of the different salespersons or the different groups. Although a tabular presentation may be used to provide such a contrast, a graphic presentation is often more efficient for illustrating the contrast among peers.

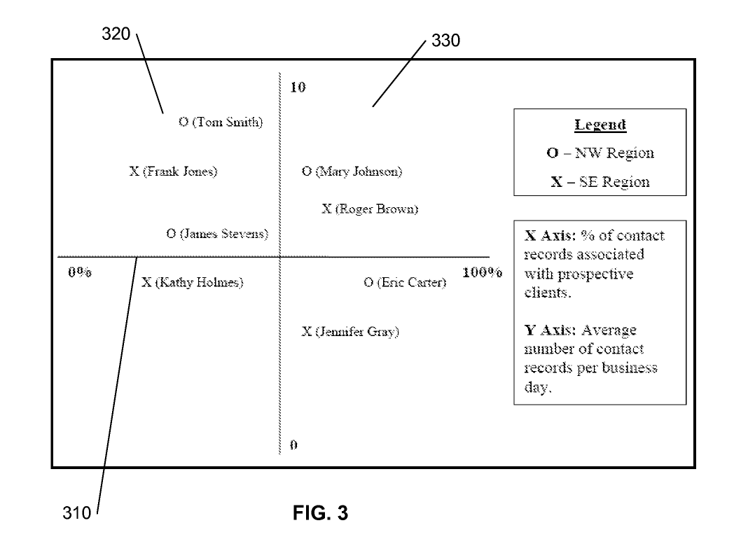

FIG. 3 illustrates an example peer-based report. In this example, two non-revenue metrics associated with the salespersons actions are rendered: the average number of contacts per day within the time period of interest and the percentage of contacts with potential clients within the time period of interest. Such a presentation would be appropriate, for example, to determine which salespersons' performances are consistent with a particular corporation's goal with regard to the tradeoff between expanding sales to existing customers and searching for new customers.

In either case, one may assume that the salespersons whose average number of contacts fall below the average 310 of the salespersons being assessed need to be counseled to increase their efforts with regard to contacting existing or potential clients.

If the corporation's goal is maximizing current revenue, the corporation would favor salespersons whose performance metrics lie in the upper left quadrant 320 of the graph of FIG. 3, because these salespersons are making more contacts than average, and a majority of their contacts are with existing clients, who are more likely to generate near-term revenue.

On the other hand, if the corporation's goal is to maximize future potential, the corporation would favor salespersons whose performance metrics lie in the upper right quadrant 330 of the graph of FIG. 3, because these salespersons are making more contacts than average, and a majority of their contacts are with potential future clients.

In the use of this example peer-based report, it is expected that the corporation will make it apparent which quadrant of performance is favored, and which quadrants are not favored with regard to the corporate goals. In this manner, all of the sales personnel are aware of the corporate expectations, and all of the sales personnel are assessed with regard to a common set of criteria, thereby providing for an objective, quantifiable, and consistent assessment of their performance.

Further, the corporation can also use such a report to provide interim re-directs of corporate goals. For example, if a corporation that is generally oriented toward long-term growth currently finds itself in need of funds, it can advise its sales personnel that performance in the upper left quadrant is preferred temporarily, until the current revenue problem is resolved. In like manner, a corporation that finds itself sufficiently comfortable with existing revenues may advise its sales personnel that performance in the upper right quadrant is preferred.

As noted above, it is also expected that the corporation, or group managers, will ‘reward’ the salespersons whose performances lie in the preferred region of the performance graph, thereby providing a material advantage to these salespersons for achieving the desired performance, even though the achieved performance is not necessarily directly related to prior/current revenue factors.

One of skill in the art will recognize that alternative forms of comparative illustrations of performance comparisons may be developed in view of the principles presented in this disclosure. For example, instead of distinguishing quadrants based on the average performance fact (in FIG. 3, the average number of contacts per day), a particular performance level may be established, such that performance below this specified performance level is considered ‘poor’, regardless of the average performance level. In like manner, even if a corporation may prefer performance in the quadrant 320 or 330, there may be ‘extremes’ that the corporation deems to be unacceptable, such as devoting less than 10% or more than 90% of one's time contacting potential contacts. On some peer reports, if it is not immediately obvious which performance regions are consistent with corporate goals, graphic indicators, such as ‘red’ regions indicating poor performance regions and ‘gold’ regions indicating excellent performance regions, may be provided. One of skill in the art will recognize that any of a variety of techniques may be employed to clearly distinguish performance regions that are consistent with corporate goals.

In like manner, instead of the use of “X”s and “O”s as illustrated in the example drawings, different color markers may be used to distinguish among different groups, different types of contacts, different types of accounts, and so on. Similarly, other visual effects, such as blinking or flashing, may be used to highlight target individuals. These and other display techniques that facilitate distinguishing aspects of the presented information will be evident to one of skill in the art in view of this disclosure.

In like manner, one of skill in the art will recognize that alternative techniques may be used to determine the performance metrics associated with the salesperson's action records. For example, if one particular client is expected to execute a high-priced purchase, either because of the particular product or the quantity of products, while another is expected to execute a relatively low-priced purchase, the performance metric related to each contact may be weighted based on the expected revenue. Similarly, if a particular product line is being ‘pushed’, the performance metric related to contacts that are likely to purchase these products may be inflated compared to contacts for other products. These and other techniques for assessing actions that are predicted to lead to situations consistent with current corporate goals will be evident to one of skill in the art in view of this disclosure.

Of particular note, in a preferred embodiment of this invention, the corporation defines how the performance metrics are calculated, including the aforementioned weighting techniques, and defines reports that clearly distinguish between performance metrics that are consistent with corporate goals and those that are inconsistent with these goals, based on a prediction of which actions are likely to achieve the corporate goals.

The foregoing merely illustrates the principles of the invention. It will thus be appreciated that those skilled in the art will be able to devise various arrangements which, although not explicitly described or shown herein, embody the principles of the invention and are thus within its spirit and scope. For example, in addition to reports that distinguish performance metrics that are consistent with corporate goals, other reports may be provided to facilitate other analyses of the salesperson's actions.

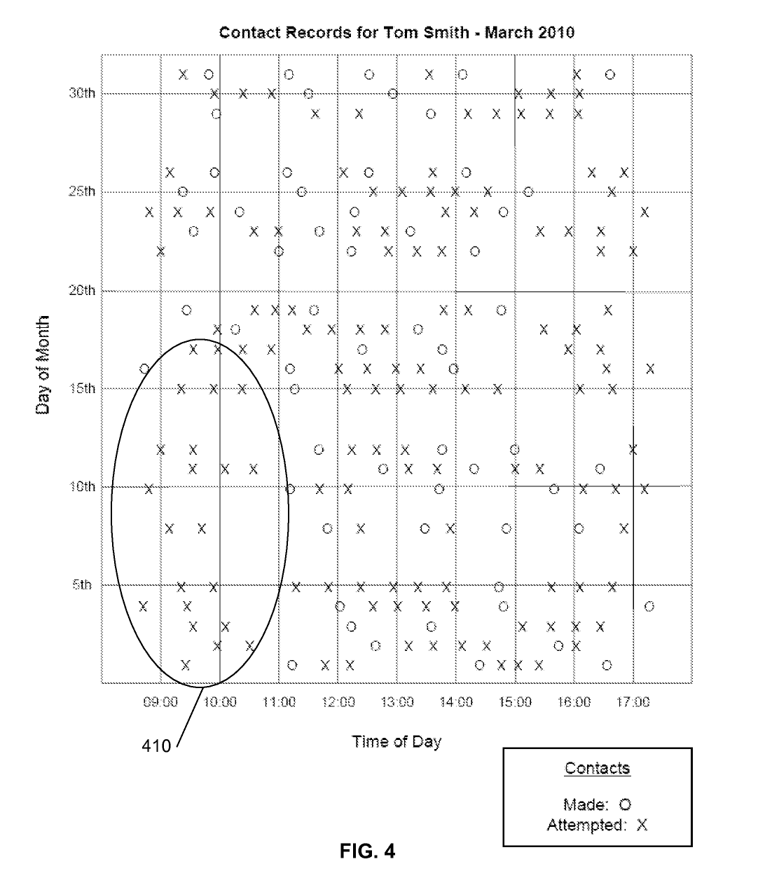

FIG. 4 illustrates, for example, attempted contacts and successful contacts as a function of the time of day, and day of the month for an individual salesperson. Such a graphic presentation may indicate that a correlation exists between successful contacts and either or both of these time factors, and the salesperson's schedule may be adjusted to increase the likelihood of success. For example as illustrated at region 410, during the first half of the month, this salesperson's contact attempts were always unsuccessful prior to 11 AM. This may suggest that the salesperson should readjust his schedule to do other tasks in the morning to free up time to attempt more contacts in the afternoon.

In like manner, such a presentation may include the actions of multiple salespersons, to distinguish patterns associated with successful salespersons from patterns associated with less-than-successful salespersons. Peer reports that illustrate performance metrics as a function of time periods, for example, may facilitate a determination of why some salespeople or some groups score higher than others. These and other system configuration and optimization features will be evident to one of ordinary skill in the art in view of this disclosure, and are included within the scope of the following claims.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry), software portions (e.g., computer programming), and any feasible combination thereof.

f) hardware portions may include a processor, and software portions may be stored on a non-transitory computer-readable medium, and may be configured to cause the processor to perform some or all of the functions of one or more of the disclosed elements;

g) hardware portions may be comprised of one or both of analog and digital portions;

h) any of the disclosed devices or portions thereof may be combined together or separated into further portions unless specifically stated otherwise;

i) no specific sequence of acts is intended to be required unless specifically indicated; and

j) the term “plurality of” an element includes two or more of the claimed element, and does not imply any particular range of number of elements; that is, a plurality of elements can be as few as two elements, and can include an immeasurable number of elements.

I claim:

1. A non-transitory computer readable medium that stores a program that, when executed by a processor, causes the processor to:
receive a plurality of action records associated with a plurality of salespersons;
process the plurality of action records to determine a plurality of performance metrics associated with each salesperson of the plurality of salespersons, at least one of the performance metrics being associated with actions associated with existing clients, and at least one of the performance metrics being associated with actions associated with potential clients;
receive a selection of a select presentation report, the presentation report being based on a predefined assessment criterion; and
present information based on the performance metrics associated with each salesperson in the select presentation report, such that a relative performance of each salesperson is apparent based on the predefined assessment criteria.

2. The medium of claim 1, wherein the performance metrics include a number of contacts with each existing client and a number of contacts with each potential client.

3. The medium of claim 2, wherein the performance metrics include a number of attempted contacts with each existing client and a number of attempted contacts with each potential client.

4. The medium of claim 2, wherein the information presented is based on a ratio of the number of contacts with each potential client and a total number of contacts with existing clients and potential clients.

5. The medium of claim 4, wherein the ratio is plotted on a graph.

6. The medium of claim 4, wherein the information presented is further based on an average number of contacts per a given time period.

7. The medium of claim 1, wherein the plurality of performance metrics includes an amount of revenue associated with each salesperson.

8. The medium of claim 1, wherein the presentation report is tabular, and the program causes the processor to present the information in a sorted order.

9. The medium of claim 1, wherein the presentation report includes attempted contacts and successful contacts as a function of time.

10. The medium of claim 9, wherein the time includes a plurality of days, and hours of each day

11. The medium of claim 1, wherein each of the action records includes: a salesperson identifier, an account identifier, and a time of action identifier.

12. The medium of claim 1, wherein the information presented is based on a time associated with the action record of at least one salesperson.

13. A method that includes:
receiving, at a data processing machine, a plurality of action records associated with a plurality of salespersons;
processing, by the machine, the plurality of action records to determine a plurality of performance metrics associated with each salesperson of the plurality of salespersons, at least one of the performance metrics being associated with actions associated with existing clients, and at least one of the performance metrics being associated with actions associated with potential clients;
receiving, by the machine, a selection of a select presentation report, the presentation report being based on a predefined assessment criterion; and
presenting, by the machine, information based on the performance metrics associated with each salesperson in the select presentation report, such that a relative performance of each salesperson is apparent based on the predefined assessment criteria.

14. The method of claim 13, wherein the performance metrics include a number of contacts with each existing client and a number of contacts with each potential client.

15. The method of claim 14, wherein the performance metrics include a number of attempted contacts with each existing client and a number of attempted contacts with each potential client.

16. The method of claim 14, wherein the information presented is based on a ratio of the number of contacts with each potential client and a total number of contacts with existing clients and potential clients.

17. The method of claim 16, wherein the ratio is plotted on a graph.

18. The method of claim 16, wherein the information presented is further based on an average number of contacts per a given time period.

19. The method of claim 13, wherein the plurality of performance metrics includes an amount of revenue associated with each salesperson.

20. The method of claim 13, wherein the presentation report is tabular, and the program causes the processor to present the information in a sorted order.

21. The method of claim 13, wherein the presentation report includes attempted contacts and successful contacts as a function of time.

22. The method of claim 21, wherein the time includes a plurality of days, and hours of each day

23. The method of claim 13, wherein each of the action records includes: a salesperson identifier, an account identifier, and a time of action identifier.

24. The method of claim 13, wherein the information presented is based on a time associated with the action record of at least one salesperson.

25. A system comprising:
a processor that processes a plurality of action records associated with a plurality of salespersons to determine a plurality of performance metrics associated with each salesperson of the plurality of salespersons, at least one of the performance metrics being associated with actions associated with existing clients, and at least one of the performance metrics being associated with actions associated with potential clients;
a user interface that receives a selection of a select presentation report, the presentation report being based on a predefined assessment criterion; and
a display that presents information based on the performance metrics associated with each salesperson in the select presentation report, such that a relative performance of each salesperson is apparent based on the predefined assessment criteria.
